(19) United States
(12) Patent Application Publication
(10) Pub. No.: US 2008/0268117 A1
(43) Pub. Date: Oct. 30, 2008

(54) METHOD OF PURIFYING OILS CONTAINING EPA AND DHA

(76) Inventors: David Rubin, San Diego, CA (US); Ely Rubin, San Diego, CA (US)

Correspondence Address: BROWDY AND NEIMARK, P.L.L.C.;624 NINTH STREET, NW, SUITE 300, WASHINGTON, DC, 20001-5303, US

(21) Appl. No.: 11/742,132

(22) Filed: Apr. 30, 2007

(51) Int. Cl. A23C 15/14

(52) U.S. Cl. 426/417

(57) ABSTRACT

Oils are washed directly with a lower alcohol to remove cholesterol and other contaminants. The washing is effected at a temperature sufficiently low that the alcohol and oil remain immiscible. The composition is then heated to form a single phase. The solution is then cooled to below 10° C. to separate the alcohol and oil phases. Undesirable components, such as cholesterol, organic contaminants, and heavy metals remain in the alcohol phase, separate from the pure oil.

### FIELD OF THE INVENTION

The present application relates to a method for purifying oils that contain EPA and DHA, that does not require saponifying the oils.

### BACKGROUND OF THE INVENTION

Oils, from whatever source, are composed mainly of triglycerides, three molecules of fatty acids joined to a glycerol molecule. The chain length of the fatty acids and their organization on the glycerol backbone vary, although most edible oils are made of fatty acids having about 16 to about 18 carbon atoms.

Many oils contain valuable ingredients in addition to conventional fatty acids, namely, eicosapentaenoic acid, or EPA, and docosahexaenoic acid, or DHA. These are essential nutrients for humans, and may have valuable anti-oxidant and heart-preventing properties.

Lipids from marine and aquatic animals such as krill, fish and sea mammals have a variety of applications, since marine and aquatic animal oils and fractions thereof contain a variety of therapeutic agents. For example, it has been reported that various marine and aquatic animal oils have anti-inflammatory properties. These oils are also reported to be helpful in reducing the incidence of cardiovascular diseases. Additionally, some marine and aquatic animal oils are reported to suppress the development of certain forms of lupus and renal diseases. As another example, krill may be used as a source of enzymes for debridement of ulcers and wounds, or to facilitate digestion of food. Marine and aquatic oils also contain various antioxidants, which may have potential therapeutic properties.

Oils from krill, Calanus and fish and sea mammals are used as dietary supplements for human diets because of their high concentration of omega-3 fatty acids. These fatty acids are essential for proper development of the brain and eye.

Among the lipids found in krill, Calanus and fish, high concentrations of fatty acids 20:5 (eicosapentaenoic acid, or EPA) and 22:6 (docosahexaenoic acid, or DHA) are present. These fatty acids are essential nutrients and are beneficial as fish feed. Furthermore, these essential nutrients are carried over in human diets by eating the fish grown on such diets.

Animals fed diets rich in omega-3 fatty acids may increase the level of unsaturated fats and decrease the amount of cholesterol in their meat. This property is widely used in the poultry industry to improve the quality of lipids in eggs.

Many different methods are known for extracting marine and aquatic animal oils. For example, it is known to extract fish oil using organic solvents such as hexane and ethanol. It is also known to extract the fat in fish muscle using acetone.

Vegetable oils, generally obtained from seeds and fruits such as olives, are obtained through expression (pressing) or solvent extraction from the source. A number of different types of refining processes can be used to obtain EPA and/or DHA from these oils, including saponification, extraction, and the like.

Zosel, in U.S. Pat. No. 4,331,695, describes a method for extracting oils using pressurized solvents which are gaseous at room temperature, such as propane, butane or hexane. The extraction is conducted at temperatures of 15 to 80° C. on shredded vegetable or finely divided animal products. The extracted oils are then precipitated under high pressure and elevated temperatures of 50 to 200° C. Among the disadvantages of this technique are that hexane is a poor extraction solvent for oils from marine animals such as Krill, and the high temperatures used in the precipitation step adversely affect the lipids in oils from any source.

Canadian patent 2,115,571 describes a method for extracting oil from brown and red algae species. This method uses Soxhlet extraction using nearly pure ethanol for 40 hours.

Rubin et al., in U.S. Pat. No. 5,006,281, disclose a method for extracting oil from marine and aquatic animals such as fish by first treating the flesh with an antioxidant compound, and centrifuging the material to separate the oil phase from the aqueous phase and the solid phase. The oil phase is then further treated with antioxidant to remove undesirable odor or taste.

Canadian patent 1,098,900 describes a method for extracting oils from krill by emulsifying fresh or defrosted krill in an aqueous medium. The oil fraction is recovered by centrifugation.

Beaudoin et al., in U.S. Pat. No. 6,800,299, disclose extracting oils from marine animals in a ketone fraction and extracting the oils with alcohol or esters of acetic acid to extract the total lipid fraction.

Zucker, in U.S. Pat. No. 1,678,454, discloses removing cholesterol from cod liver oil by cold extraction of cod liver oil with ethanol, followed by saponification of the oil.

Buxton, U.S. Pat. No. 2,347,460, obtains fat-soluble vitamins from vitamin-containing oils having an unsaponifiable content of at least 2% by contacting the oils with hot ethanol or methanol and then cooling the mass to below about 0° C. The alcoholic extracts are rich in fat-soluble vitamins.

Unfortunately, known processes are generally commercially unfeasible or provide low quantitative yields.

### SUMMARY OF THE INVENTION

Oils are extracted from the source, e.g., seeds, krill, Calanus, fish or other aquatic animals, and are washed directly with a lower alcohol, such as but not limited to ethanol or propanol, isopropanol or butanol. These alcohols are used at a temperature low enough to ensure that the alcohol and oil remain immiscible, generally lower than about 10° C. This temperature, of course, may vary depending on the oil treated and the alcohol used. At temperatures above about 10° C. the oil and the alcohol will be miscible and the impurities will not be separated from the oils. The composition is then heated to a temperature sufficient to form a single phase. The solution is then cooled to below 10° C. to separate the alcohol and oil phases. Undesirable components, such as cholesterol, organic contaminants, and heavy metals remain in the alcohol phase, separate from the pure oil.

In a preferred embodiment, the alcohol is 60-70% aqueous solution. This concentration of alcohol provides superior separation and removal of impurities such as cholesterol, methyl mercury, etc., than if the percentage of alcohol is higher, up to absolute alcohol.

Once the alcohol has been added to the oil source, the mixture is cooled to a point at which two phases are formed, generally about 10° C. or less. This mixture is then heated to a point at which the oil and alcohol are miscible. This usually occurs at about 70-75° C. The solution is cooled to a point at which a clear separation appears between the aqueous phase and the organic phase, generally about 40-60° C. The alcohol/water phase becomes opaque; it appears that the impurities precipitate from the water/alcohol phase, rather than migrate back to the oil phase. This one step procedure yields the same result as the same procedure repeated twice more using absolute or 95% alcohol.

### DETAILED DESCRIPTION OF THE INVENTION

To extract oil from marine animals, the animal material is comminuted and the easily extracted oil is removed, either by heating or by cold pressing. Cold pressing is preferred so as not to oxidize free fatty acids in the fish cell membranes.

To extract oil from seeds, the seeds are preferably cold pressed. The oil used in the present process is preferably as fresh as possible so that there is no degradation of the fatty acids in the oil. Naturally occurring oils high in EPA and DHA include those vegetables such as olives, cottonseed, rapeseed and corn, as well as those from marine oils such as colored fish, including mackerel, sardine, mackerel pike and herring; cod liver oil; marine animals such as krill and various shrimp-like animals, such as Calanus, a marine copepod. It should be understood, however, that any source of oil containing EPA and DHA can be used in the present process.

Preferably, the source fish oils are obtained from as cold an environment as possible. The optimal enzymatic activity for the enzyme α⁵-desaturase, which catalyzes the conversion of eicosatetraenoic acid to EPA, occurs at 9° C. Thus, marine animals from cold waters are higher in EPA than marine animals from warmer waters.

Furthermore, oils having even greater amounts of EPA can be obtained if the marine animals are raised in a controlled environment. If the animals are fed a diet rich in α-linoleic acid and maintained in water at about 9° C., optimum amounts of EPA in the oil will be obtained.

The oils to be extracted are washed directly with a C₁₋C₄ alcohol, such as ethanol, propanol, butanol etc. The alcohol is in aqueous solution of from about 50% alcohol to absolute alcohol. However, alcohol concentrations of about 60-70% are preferred, as using this concentration of alcohol makes it possible to perform the extraction in one step. Using absolute or 95% alcohol requires three washes of the oil to obtain the same purity of oil extracted with 60-70% alcohol.

Preferably, about three parts alcohol are added to one part oil, although the amount of alcohol can range from about two parts to about five parts per one part oil.

### EXAMPLE

Three parts 65% aqueous ethanol were added to one part fish oil. This mixture of oil and 65% ethanol was then heated to 70-75° C., at which point the mixture became miscible. The mixture was allowed to cool at room temperature. When the temperature of the mixture reached about 50° C., a clear separating line appeared between the two liquids. The ethanol/water phase became opaque. It appeared that the impurities precipitated from the aqueous ethanol rather than migrating back to the oil. The oil phase was recovered by removing the aqueous phase.

As noted above, when 95% or absolute alcohol is added, the oil must be washed three times to achieve the same purity as when using 60-70% aqueous ethanol.

The present process is particularly useful for preparing oils for use in foods and pharmaceuticals, as the process removes organic contaminants such as cholesterol and heavy metals such as methyl mercury.

The oils prepared as described herein are particularly useful for preparing infant formula, as described in Rubin, U.S. Pat. No. 5,013,569, the entire contents of which are incorporated hereby reference; for preparing compositions for treating rheumatoid arthritis, as described in Rubin, U.S. Pat. No. 4,843,095, the entire contents of which are incorporated herein by reference; and for preparing pure EPA and DHA as described in Rubin, U.S. Pat. No. 6,846,942, the entire contents of which are incorporated herein by reference.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A method for purifying oils containing EPA and DHA comprising:
(a) adding to the oil an alcohol selected from the group consisting of C₁₋C₄ aliphatic alcohols at a temperature at which the oil and the alcohol separate into two phases;
(b) heating the mixture of oil and alcohol to cause the alcohol and oil to become miscible;
(c) cooling the mixture of alcohol, and oil to a temperature at which the oil phase and the alcohol phase separate; and
(d) recovering the oil phase.

2. The method according to claim 1, wherein the alcohol is about 60-70% aqueous solution.

3. The method according to claim 2, wherein the alcohol is ethanol or propanol.

4. The method according to claim 3, wherein the alcohol is ethanol.

5. The method according to claim 1, wherein the oil is obtained from marine animals.

6. The method according to claim 1, wherein the oil is obtained from seeds or fruits.

7. The method according to claim 1, wherein the temperature at which the oil and alcohol separate into two phases in step (a) is about 10° C.

8. The method according to claim 1, wherein the temperature at which the oil and alcohol become miscible is about 50 to 80° C.

9. The method according to claim 1, wherein the mixture of alcohol and oil are cooled in step (c) to a temperature of about 10° C.
